(19) United States
(12) Patent Application Publication
(10) Pub. No.: US 2005/0022233 A1
(43) Pub. Date: Jan. 27, 2005

(54) Method and apparatus for storing/reproducing data in multimedia system

(76) Inventor: Jong-Lak Park, Suwon-Si (KR)

Correspondence Address: LAW OFFICE OF MONICA H CHOI, P O BOX 3424, DUBLIN, OH, 430160204, US

(21) Appl. No.: 10/867,492

(22) Filed: Jun. 14, 2004

(30) Foreign Application Priority Data
Jul. 26, 2003 (KR) 2003-0042136

(51) Int. Cl. H04N 7/16; H04N 7/10; H04N 7/025

(52) U.S. Cl. 725/32; 725/135; 725/136

(57) ABSTRACT

For storing/reproducing data within a multimedia system, only stream information is extracted and recorded on a disc of a disc drive and non-stream information is stored in a separate data storage unit. For example, the separate data storage unit is a non-volatile memory device such as a flash memory device. Because the non-stream information is stored and retrieved from the separate data storage unit, the seek time for the stream information is advantageously shortened during the read/write of the stream information from/to the disc of the disc drive.

### BACKGROUND OF THE INVENTION

This application claims priority to Korean Patent Application No. 2003-0042136, filed on Jul. 26, 2003, in the Korean Intellectual Property Office, the disclosure of which is incorporated herein in its entirety by reference.

1. Field of the Invention

The present invention relates to storing/reproducing data in a multimedia system, and more particularly, to storing/reproducing data in a multimedia system by storing additional information, which is used to manage stream information, on a separate storage medium other than a HDD (hard disc drive) on which stream information is recorded.

2. Description of the Related Art

In general, a multimedia system includes an audio/video (AV) appliance that processes an AV signal and a storage unit that stores data processed by the AV appliance.

FIG. 1 is a block diagram of a conventional multimedia system that stores/reproduces data. Referring to FIG. 1, in order to record data processed by an AV appliance 110, e.g., a host appliance, on a disc 150 of a hard disc drive (HDD) (not shown), the conventional multimedia system generates both AV stream data S and additional information A, which is used to manage the AV stream data S, and sends them to the AV appliance 110. Then, the AV stream data S and the additional information A are transmitted to a host buffer 120, an interface circuit 130, and finally to an HDD buffer 140 of the HDD. In general, the AV stream data S is a large amount of data recorded with continuous addresses, and the additional information A specifies the names, sizes, and locations of files necessary to manage the AV stream data S and is a small amount of data that is recorded with different addresses from those of the AV stream data S.

The HDD reads the information from the HDD buffer 140 and records the AV stream data S and the additional data A on a user data storage region of the disc 150 and an address region, on which a file allocation table is recorded, respectively.

To reproduce the AV stream data S, which is processed by the AV appliance 110, from the disc 150, the additional information A must be read from the file allocation table recorded on the disc 150 to determine the location of a file containing the AV stream data S on the disc 150 before data reproduction. Next, the location of the file is searched for and the AV stream data S stored in the file is reproduced.

In conclusion, additional information must be recorded on the disc 150 in a file allocation table format or be reproduced from the disc 150 prior to recording/reproducing AV data on/from the disc 150. Accordingly, since file seek time is required to record or reproduce the additional information, disc access time increases when there are lots of AV files used during a write/read operation.

A method of reducing disc access time required by a hard disc drive is disclosed in Japanese Laid-Open Patent Publication No. 1995-192017 entitled “Multi-Medium Information Retrieval System”. The multi-medium information retrieval system further requires an apparatus for detecting information necessary for management of a magneto-optical disc and a separate hard disc drive for managing an index table, in addition to an apparatus for reproducing data from a magneto-optical disc, so as to reduce disc access time. However, in this method, additional information is stored in an index table of a hard disc, thus requiring a lot of seek time for accessing the additional information.

### SUMMARY OF THE INVENTION

The present invention stores/reproduces data in a multimedia system, in which only stream information is extracted and recorded on a disc of a disc drive and non-stream information is stored in a separate storage unit.

According to one aspect of the present invention, in a method and apparatus for storing information within a multimedia system, an AV (audio/video) controller divides the information into stream information and non-stream information. A disc drive controller determines at least one available target track of the disc onto which the stream information is to be stored. An interface circuit stores the non-stream information and information regarding the at least one available target track in an additional memory unit separate from the disc. The disc drive controller writes the stream information in the at least one available target track of the disc.

In another aspect of the present invention, in a method and apparatus for reproducing stream information within a multimedia system, the interface circuit retrieves, from the additional memory unit, the non-stream information to determine identification of the at least one target track onto which the stream information is stored. The disc drive controller reads the stream information from the at least one target track.

In an example embodiment of the present invention, the stream information includes audio stream information and video stream information, and the non-stream information includes the names, sizes, and locations of A/V data files of the stream information.

In another example embodiment of the present invention, the additional memory unit is a non-volatile memory device such as a flash memory device.

In this manner, because the non-stream information is stored and retrieved from the additional memory unit that is separate from the disc of the disc drive, the seek time for the stream information is advantageously shortened during the read/write of the stream information from/to the disc of the disc drive.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a block diagram of a conventional multimedia system that stores and reproduces data;

FIG. 2 is a block diagram of a multimedia system that stores and reproduces data, according to an embodiment of the present invention;

FIG. 3 is a detailed block diagram of a multimedia system that stores and reproduces data, according to another embodiment of the present invention;

FIG. 4 is a flowchart illustrating a method of storing data in a multimedia system, according to an embodiment of the present invention;

FIG. 5 is a flowchart illustrating a method of reproducing data in a multimedia system, according to an embodiment of the present invention;

FIG. 6 is a flowchart illustrating sub-steps of a step of FIG. 4, according to an embodiment of the present invention; and

FIG. 7 is a flowchart illustrating sub-steps of a step of FIG. 5, according to an embodiment of the present invention.

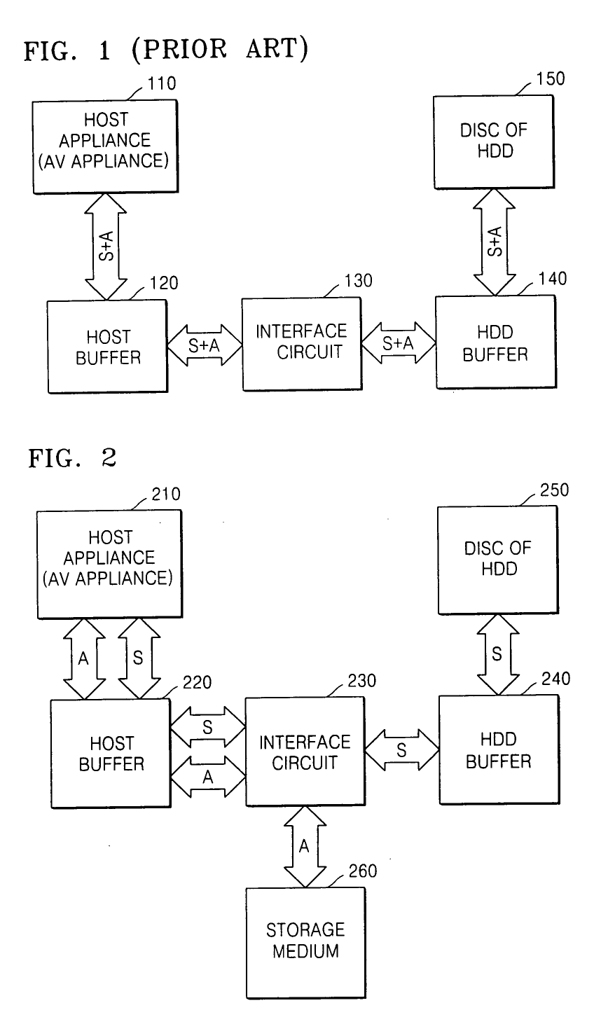

The figures referred to herein are drawn for clarity of illustration and are not necessarily drawn to scale. Elements having the same reference number in FIGS. 1, 2, 3, 4, 5, 6, and 7 refer to elements having similar structure and/or function.

### DETAILED DESCRIPTION OF THE INVENTION

FIG. 2 is a block diagram of a multimedia system that stores and reproduces data according to an embodiment of the present invention. Referring to FIG. 2, the multimedia system includes a host appliance 210, a host buffer 220, an interface circuit 230, a hard disc drive (HDD) buffer 240, a disc 250 of a HDD (not shown), and an additional data storage unit 260. The storage unit 260 is a data storage medium that is separate from the disc 250 of the HDD. The storage unit 260 is a nonvolatile memory device such as flash memory device in one example embodiment of the present invention.

An exemplary embodiment of a process of storing/reproducing data according to the present invention will now be described with reference to FIG. 2. In this embodiment, the host appliance 210 is determined to be an audio/video (AV) appliance for convenience.

The AV appliance 210 processes an input signal, divides the signal into stream information S and non-stream information A, and stores them in the host buffer 220. The non-stream information A specifies the names, sizes, and locations of AV data files.

The interface circuit 230 reads the information from the host buffer 220, stores the non-stream information A in the storage unit 260, not the disc 250, and stores the stream information S in the HDD buffer 240. The stream information S is comprised of video stream information and audio stream information, for example. The non-stream information is comprised of additional information used for handling the stream information S, for example.

The HDD reads the stream information S from the HDD buffer 240, converts the read stream information S into a recordable signal, and records the signal on the disc 250.

Consequently, only AV stream information, i.e., the stream information S, is stored in the disc 250 and non-stream information A, which is used to manage the stream information S, is stored in the storage unit 260, not the disc 250.

Next, a read mode in which information is read from a hard disc will be described.

In the read mode, the interface circuit 230 reads additional information from the non-stream information A stored in the storage unit 260 and transmits it to the host appliance 210 via the host buffer 220. The additional information is used for management of the stream information S. Next, a controller (not shown) in the host appliance 210 generates a read command based on the additional information and transmits the read command to the host buffer 220.

Then, the read command is transmitted to the interface circuit 230, and finally to the HDD. Upon receiving the read command, the HDD reads the stream data S from a target track of the disc 250 and transmits it to the host interface 210.

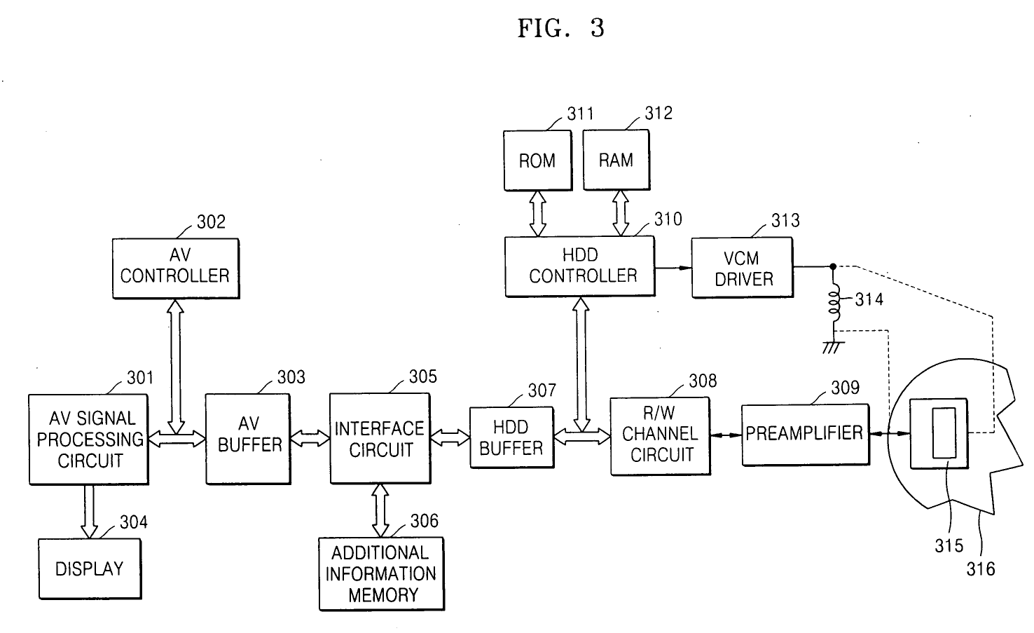

Next, a multimedia system according to an embodiment of the present invention will be described in a greater detail with reference to FIG. 3.

As shown in FIG. 3, the multimedia system, which includes an AV appliance and an HDD, includes an AV signal processing circuit 301, an AV controller 302, an AV buffer 303, a display 304, an interface circuit 305, an additional information memory 306, an HDD buffer 307, a read/write (R/W) channel circuit 308, a preamplifier 309, an HDD controller 310, a read only memory (ROM) 311, a random access memory (RAM) 312, a voice coil motor (VCM) driver 313, a voice coil 314, a transducer 315, and a disc 316.

The AV signal processing circuit 301 consists of circuits, each circuit including a digital signal processor (DSP) that encodes and decodes an AV signal to record and reproduce the AV signal. Also, the AV signal processing circuit 310 processes an AV signal in a mode corresponding to a command generated by the AV controller 302.

The AV controller 302 controls overall operations of the AV appliance and acts as a host controller of the multimedia system. In particular, in a write mode, the AV controller 302 performs a process of dividing information, which is processed by the AV signal processing circuit 301, into stream information and non-stream information and storing these information in the AV buffer 303.

The AV buffer 303 temporarily stores data processed by the AV signal processing circuit 301 or data transmitted from the HDD via the interface circuit 305.

The display 304 outputs a video signal reproduced by the AV signal processing circuit 301 to a screen.

The interface circuit 305 allows exchange of information between the AV appliance and the HDD. In particular, in the write mode, the interface circuit 305 stores non-stream information and stream information from the AV buffer 303 in the additional information memory 306 and the HDD buffer 307, respectively.

A multiplicity of non-stream information is stored in the additional information memory 306. The non-stream information includes additional information that is recorded in a file allocation table to manage the stream information. The additional information memory 306 is separate from the disc 316 of the HDD. The additional information memory 306 is a non-volatile memory device such as a flash memory device in an example embodiment of the present invention.

The HDD buffer 307 temporarily stores information reproduced by the R/W channel circuit 308 of the HDD or stores stream information processed by the AV appliance.

In the read mode, the R/W channel circuit 308 converts an analog signal, which is read by the transducer 315 and amplified by the preamplifier 309, into digital data so that the analog signal can be read by the AV appliance. In the write mode, the R/W channel circuit 308 converts stream information, which is read by the HDD buffer 307, into an analog signal so that the stream information can be recorded on the disc 316.

The preamplifier 309 amplifies a signal to be recorded on the disc 316, generates a write current, and applies the write current to the transducer 315 in the write mode. Alternatively, the preamplifier 309 amplifies a signal detected by the transducer 315 and outputs the amplified signal to the R/W channel circuit 308 in the read mode.

The HDD controller 310 controls overall operations of the HDD in accordance with a command transmitted from the AV controller 302.

The ROM 311 and the RAM 312 stores commands and data used by the HDD controller 310 to execute a variety of software routines.

The VCM driver 313 generates a driving current that allows the transducer 315 to be moved according to seek control by the HDD controller 310.

Hereinafter, a write mode is described in greater detail in which information processed by a multimedia system is stored in a disc of an HDD, and a read mode in which such information is reproduced, according to an embodiment of the present invention.

First, a method of storing data in the write mode in a multimedia system will be described with reference to FIGS. 3, 4, and 6.

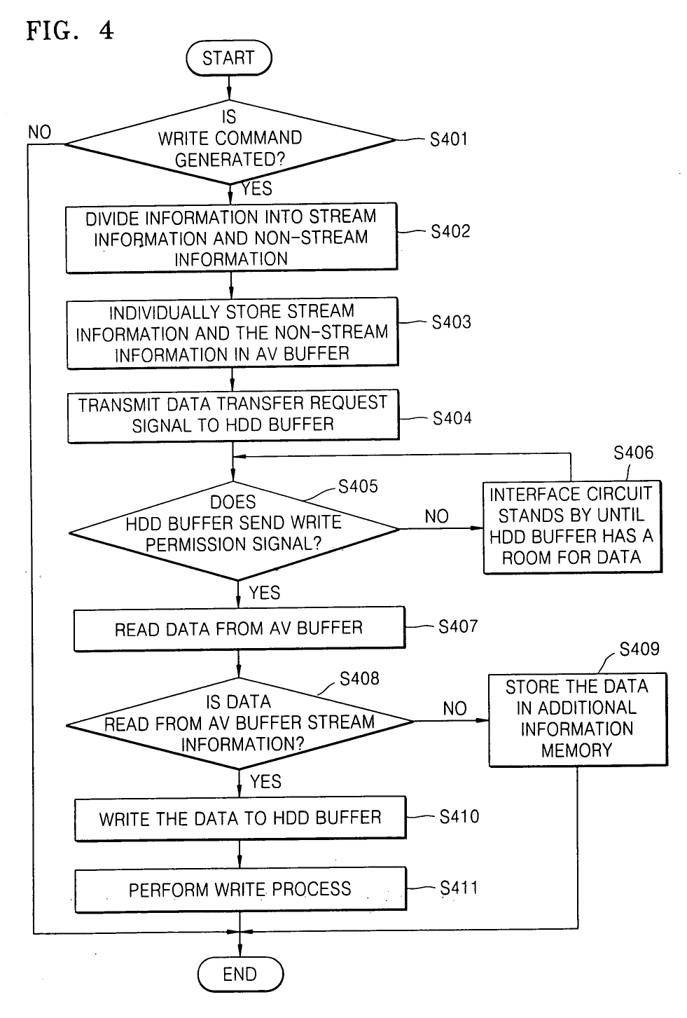

Referring to FIG. 4, in step 401, whether the AV controller 302 generates a write command to enter the write mode is checked.

In step 402, when entry into the write mode is determined, the AV controller 302 divides data processed by the AV signal processing circuit 301 into stream information and non-stream information. In step 403, the stream information and non-stream information are individually stored in the AV buffer 303. The stream information S is comprised of video stream information and audio stream information, for example. The non-stream information is comprised of additional information used for handling the stream information S, for example.

In step 404, the interface circuit 305 transmits a data transfer request signal to the HDD buffer 307.

In step 405, whether the HDD buffer 307 sends a write permission signal to the interface circuit 305 is checked. If the HDD buffer 307 has space to store data, the HDD buffer 307 sends the write permission signal to the interface circuit 305. In step 406, the interface circuit 305 stands by until the HDD buffer 307 has room for storing data. When the HDD buffer 307 has no room for storing data, the HDD buffer 307 generates a stand-by signal indicating that the HDD buffer 307 is full, and sends the stand-by signal to the interface circuit 305. Then, the method returns to step 405.

In step 407, when it is determined in step 405 that the HDD buffer 307 sends the write permission signal to the interface circuit 305, the interface circuit 305 reads data from the AV buffer 303. In step 408, it is determined whether the data read from the AV buffer 303 is stream information or not.

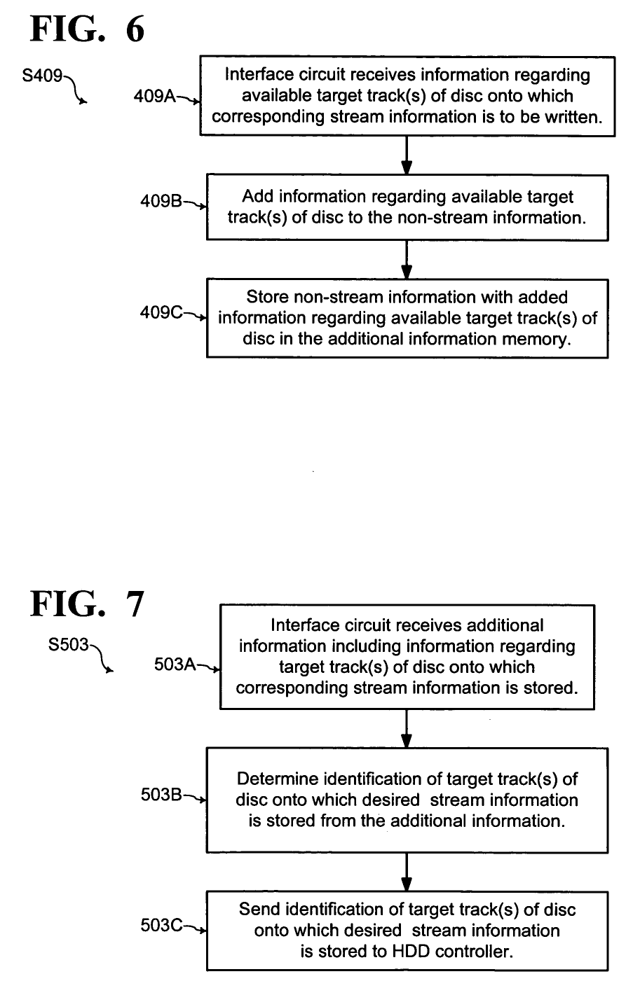

In step 409, when the data read from the AV buffer 303 is not stream information, the data is written to the additional information memory 306. FIG. 6 shows a flow-chart of sub-steps of the step 409 of FIG. 4, according to an example embodiment of the present invention. Referring to FIGS. 3, 4, and 6, the interface circuit 305 receives from the HDD controller 310 information regarding available target track(s) of the disc 316 (step 409A of FIG. 6) onto which corresponding stream information is to be written in step 411. The interface circuit 305 adds the information regarding such available target track(s) of the disc 316 to the additional (non-stream) data from the AV buffer 303 (step 409B of FIG. 6). The interface circuit 305 then stores into the additional information memory 306 (step 409C of FIG. 6) the total of the additional (non-stream) information from the AV buffer 303 and the information regarding the available target track(s) of the disc 316 onto which corresponding stream information is to be written in step 411.

In step 410, when the data read from the AV buffer 303 is stream information, the data is written to the HDD buffer 307. In step 411, the stream information is read from the HDD buffer 307, converted into an analog signal so that the R/W channel circuit 308 can record the stream information on the disc 316, amplified by the preamplifier 309, and recorded on the available target tracks of the disc 316 using the transducer 315.

Second, a method of reproducing data in a multimedia system in the read mode, according to an embodiment of the present invention, will now be described with reference to FIGS. 3, 5, and 7.

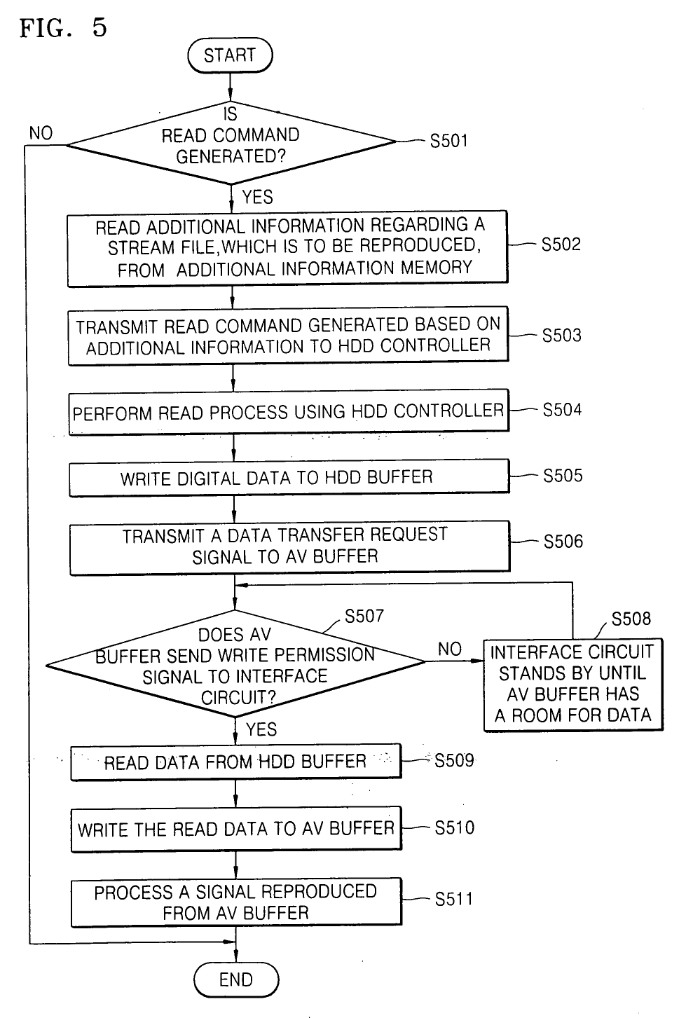

Referring to FIG. 5, in step 501, whether the AV controller 302 generates a read command to enter the read mode is checked.

In step 502, when entry into the read mode is checked, the interface circuit 305 reads additional information regarding a stream file, which is to be reproduced, from the additional information memory 306 and transmits the additional information to the AV controller 302 via the AV buffer 303, under a control command given by the AV controller 302.

In step 503, the AV controller 302 generates a read command based on the additional information regarding the stream file and transmits the read command to the AV buffer 303. Then, the read command is transmitted to the interface circuit 305 and finally to the HDD controller 310.

FIG. 7 shows a flow-chart of sub-steps of the step 503 of FIG. 5, according to an example embodiment of the present invention. Referring to FIGS. 3, 5, and 7, the interface circuit 305 retrieves from the additional information memory 306 the additional (non-stream) information including information regarding the target track(s) of the disc 316 onto which desired stream information is stored (step 503A of FIG. 7). The interface circuit 305 determines from the additional information the identification of the target track(s) of the disc 316 onto which the desired stream information is stored (step 503B of FIG. 7). The interface circuit 305 then sends the identification of the target track(s) of the disc 316 onto which the desired stream information is stored to the HDD controller 310 along with the read command (step 503C of FIG. 7).

In step 504, the HDD controller 310 receives and analyzes the read command, generates a driving voltage for moving the transducer 315 to the target tracks of the disc 316, and outputs the driving voltage to the VCM driver 313.

Then, a signal recorded on the target tracks of the disc 316 is detected by the transducer 315 and amplified by the preamplifier 309. The R/W channel circuit 308 converts the amplified signal into digital data that can be read by the AV signal processing circuit 301.

In step 505, the HDD controller 310 writes digital data reproduced by the R/W channel circuit 308 to the HDD buffer 307. In step 506, the interface circuit 305 sends a data request signal to the AV buffer 303.

In step 507, it is checked whether the AV buffer 303 sends a write permission signal to the interface circuit 305. More specifically, when the AV buffer 303 has room for storing data, the AV buffer 303 sends the write permission signal to the interface circuit 305. In step 508, the interface circuit 305 stands by until the AV buffer 303 has room for data. When the AV buffer 303 has no room for data, the AV buffer 303 generates a stand-by signal indicating that the AV buffer 303 is full, and sends the stand-by signal to the interface circuit 305.

In step 509, when the write permission signal is sent to the interface circuit 305, the interface circuit 305 reads data from the HDD buffer 307. In step 510, the interface circuit 305 writes the read data to the AV buffer 303.

In step 511, when the AV controller 302 reads the data from the AV buffer 303 and outputs it to the AV signal processing circuit 301, the AV signal processing circuit 301 divides the data into video data and audio data, individually processes the AV data in accordance with related signal processing standards, outputs a video signal reproduced from the video data to the display 304, and outputs an audio signal reproduced from the audio data to a speaker (not shown).

Consequently, only stream information is recorded on a disc of a disc drive in a multimedia system and non-stream information is stored in a separate storage unit, not the disc, thereby reducing amounts of data seek time spent during a write/read operation.

As described above, according to the present invention, information processed by a host appliance in a multimedia system is divided into stream information and non-stream information. Only the stream information is recorded on a disc of a disc drive and the non-stream information is recorded in a separate storage unit, not the disc. Accordingly, it is possible to reduce amounts of data seek time and read/write time required to read/write the non-stream information, which is used to manage the stream information, from/to the disc in order to read/write the stream information. Also, since only the stream information, i.e., one type of data, is recorded on the disc, it is possible to reduce the occurrence of disc defects.

The present invention can be realized as a method, an apparatus, a system, and so on. When the present invention is realized as software, the members of the present invention are code segments which execute necessary operations. Programs or code segments may be stored in a processor readable medium or may be transmitted by a transmission medium or by a computer data signal combined with a carrier in a communication network. The processor readable medium may be any medium, such as an electronic circuit, a semiconductor memory device, a ROM, a flash memory, an erasable ROM, a floppy disc, an optical disc, a hard disc, an optical fiber medium, or a radio frequency (RF) network, which can store or transmit information. The computer data signal may be any signal which can be transmitted through a transmission medium such as an electronic network channel, an optical fiber, air, an electromagnetic field, or an RF network.

While this invention has been particularly shown and described with reference to embodiments thereof, it will be understood by those skilled in the art that various changes in form and details may be made therein without departing from the spirit and scope of the invention as defined by the appended claims.

1. A method of storing/reproducing information within a multimedia system, comprising:
dividing the information into stream information and non-stream information;
determining at least one available target track of a disc of a disc drive onto which the stream information is to be stored; and
storing the non-stream information and information regarding the at least one available target track in an additional memory unit separate from the disc.

2. The method of claim 1, further comprising:
storing the stream information in the at least one available target track of the disc.

3. The method of claim 1, wherein the stream information includes audio stream information and video stream information.

4. The method of claim 1, wherein the additional memory unit is a non-volatile memory device.

5. The method of claim 1, wherein the non-stream information includes the names, sizes, and locations of files.

6. The method of claim 1, further comprising:
retrieving, from the additional memory unit, the non-stream information including the information regarding the at least one target track of the disc onto which the stream information is stored; and
reading the stream information from the at least one target track of the disc.

7. A method of reproducing stream information stored in a disc of a disc drive of a multimedia system, comprising:
retrieving, from an additional memory unit separate from the disc, non-stream information including information regarding at least one target track of the disc onto which the stream information is stored;
determining identification of the at least one target track onto which the stream information is stored; and
reading the stream information from the at least one target track of the disc.

8. The method of claim 7, wherein the stream information includes audio stream information and video stream information.

9. The method of claim 7, wherein the additional memory unit is a non-volatile memory device.

10. The method of claim 7, wherein the non-stream information includes the names, sizes, and locations of files.

11. An apparatus for storing/reproducing information within a multimedia system, comprising:
an AV (audio/video) controller for dividing the information into stream information and non-stream information;
a disc of a disc drive for storing the stream information;
a disc drive controller for determining at least one available target track of the disc onto which the stream information is to be stored; and
an additional memory unit, that is separate from the disc, for storing the non-stream information and information regarding the at least one available target track.

12. The apparatus of claim 11, wherein the stream information includes audio stream information and video stream information.

13. The apparatus of claim 11, wherein the additional memory unit is a non-volatile memory device.

14. The apparatus of claim 11, wherein the non-stream information includes the names, sizes, and locations of files.

15. The apparatus of claim 11, further comprising:
an interface circuit for retrieving, from the additional memory unit, the non-stream information including the information regarding the at least one target track of the disc onto which the stream information is stored;
wherein the disc drive controller reads the stream information from the at least one target track of the disc.

16. An apparatus for reproducing stream information within a multimedia system, comprising:
a disc of a disc drive that stores the stream information;
an additional memory unit, separate from the disc, that stores non-stream information including information regarding at least one target track of the disc onto which the stream information is stored;
an interface circuit that retrieves, from an additional memory unit, non-stream information to determine identification of the at least one target track onto which the stream information is stored; and
a disc drive controller for reading the stream information from the at least one target track.

17. The apparatus of claim 16, wherein the stream information includes audio stream information and video stream information.

18. The apparatus of claim 16, wherein the additional memory unit is a non-volatile memory device.

19. The apparatus of claim 16, wherein the non-stream information includes the names, sizes, and locations of files.
